(19) United States
(12) Patent Application Publication
(10) Pub. No.: US 2006/0015689 A1
(43) Pub. Date: Jan. 19, 2006

(54) Implementation and management of moveable buffers in cache system

(75) Inventors: Yasukichi Okawa, Kawasaki (JP); Roy Moonseuk Kim, Austin, TX (US); Peichun Peter Liu, Austin, TX (US); Thuong Quang Truong, Austin, TX (US)

Correspondence Address: Gregory W. Carr;670 Founders Square, 900 Jackson Street, Dallas, TX, 75202, US

(73) Assignees: International Business Machines Corporation, Armonk, NY (US); Sony Computer Entertainment Inc., Tokyo (JP)

(21) Appl. No.: 10/891,796

(22) Filed: Jul. 15, 2004

(51) Int. Cl. G06F 12/00

(52) U.S. Cl. 711/143; 711/146; 711/133; 711/128

(57) ABSTRACT

The present invention provides parallel processing of write-back and reload operations in a cache system and optimum circuit utilisation by implementing moveable buffers in a cache storage. However, the data and associated pointers are not permanently assigned to a particular buffer—hence, the buffers can move logically around in the facility. Reload pointer is pointing to an empty entry so that retrieved data from the main memory or equal hierarchy cache on cache miss can be always be accommodated. Victim pointer is always pointing to a modified entry for the next candidate of write-back operation. Write-back operation is necessary with reload operation in order to make a free entry for further cache miss handling unless free entry exists. Because of these moveable pointers for reload buffer and victim buffer and integrated write-back buffer in the cache, intra cache data movement is not necessary which improves cache miss handling performance.

### TECHNICAL FIELD

The present invention relates generally to the field of computer systems and, more particularly, cache buffers.

### BACKGROUND

The need for faster computer systems has led to increased demands for high-speed data fetches and stores. A cache system, which is a small, contents addressable memory, with relatively low access latency and high bandwidth, was introduced to meet these requirements.

In a write-back cache system, data modification due to a store instruction is only for the cache. Later on, such modified data write-back cache to the main memory when there is no space to accommodate reloaded data from main memory to resolve cache miss.

Therefore, in order to resolve cache miss when cache is without a free entry, the system uses two distinct operations. One is reload which retrieves demanded data from main memory and allocate it in the cache. Another is write-back cache that writes modified data from victim entry to memory in order to allocate a free entry for a reload operation. Essentially, the reload operation is unable to start as long as write-back is pending.

A conventional write-back cache system accommodates a write-back buffer, where the write-back data moves immediately after the write-back operation initiates. In this manner, write-back operation can employ the write-back buffer so that the reload operation can start utilizing victim entry immediately.

Such a write-back buffer is extra data storage outside cache system, and makes cache design difficult in terms of area and power consumption.

Therefore, there is a need for a write-back cache system that addresses at least some of the problems associated with conventional write-back cache systems.

### SUMMARY OF THE INVENTION

Methods for managing write-back and reload operations in a cache system. Then, employing a plurality of pointers and moveable buffers for receiving storage access instructions in a cache system from one or more processors. The buffers are integrated in the data array and available for reload and write-back operations. A cache controller further reserves a specified reload buffer for cache misses and write-back the victim to memory to keep the reload buffer clear for the next missed entry.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1A illustrates an exemplary conventional four-way set associative write-back cache;

FIG. 1B illustrates an exemplary conventional operational flow of cache replacement;

FIG. 1C illustrates an exemplary improved process for operational flow of cache replacement;

FIG. 2 illustrates an exemplary processor cache system interface diagram; and

FIG. 3 illustrates an exemplary cache system block diagram.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

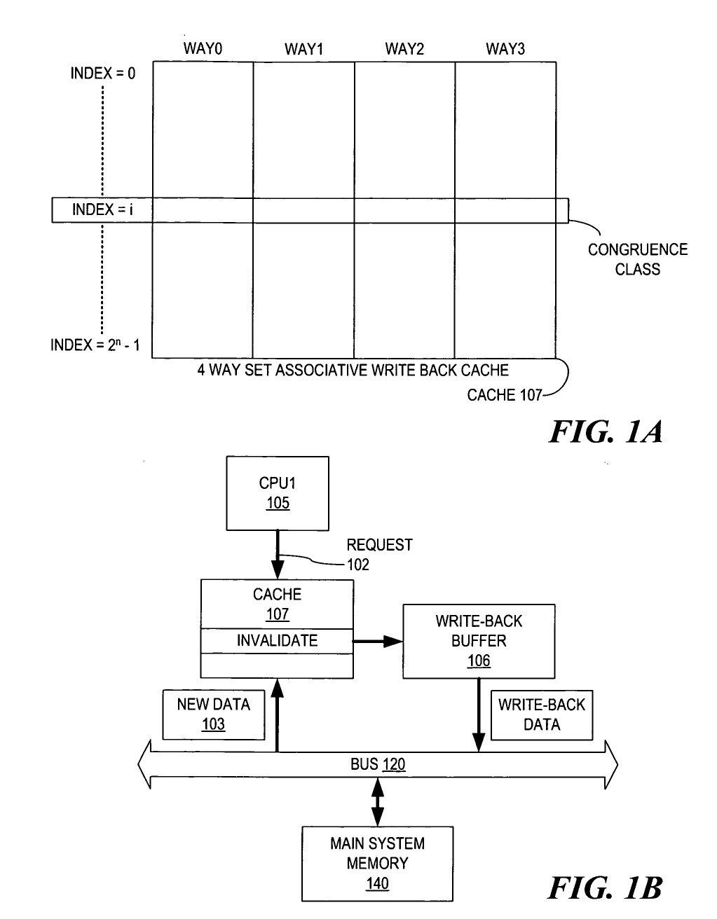

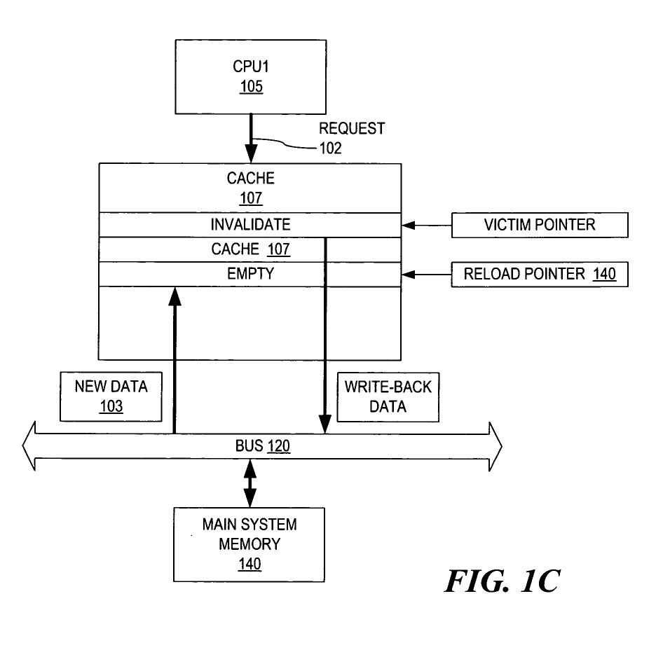

Turning to FIG. 1A disclosed is an exemplary conventional four-way set associative write-back CACHE 107. A conventional write-back cache needs replacement when a cache miss occur and there is no empty room in its congruence class. A congruence class set is a set of cache entries indexed by the same index. The cache miss is detected at Index=i. This congruence class has no empty slot. When the victim entry is chosen, and evicted, new data is reloaded, and the cache miss is resolved for the replacement reload has to follow write-back.

Turning to FIG. 1B, disclosed is an exemplary conventional operational flow of cache replacement. Shown here, two consecutive memory operations are necessary to conduct cache replacement. A conventional cache introduces a Write-Back Buffer 106 to handle both operations in parallel.

First, a program or a device makes an instruction Request 102, to processor CPU1 105. The instruction goes to a Cache 107 where it is compared by a tag (unique identifier) to the stored tag placed into Cache 107. If there is a match, the data access operation is operated within the cache. If not, a cache miss is recorded and the reload operation is initiated to reload new data to an empty (invalid) entry. If there is no empty entry, and victim calculation logic point to the modified state entry, then modified state entry is castout as a “victim” to Write-Back Buffer 106. Data writes to Main System Memory 140 when bus and main system memory is available That is, there is only ‘n’ number of available cachelines, and therefore, victim data must be pushed out to make room for the incoming data that arrives via Bus 120. Bus 120 places the new data into the victim entry line. Reload and write-back are main memory transfer operations that can result in slow transfer and high capacity utilization rates.

The Write-Back Buffer 106 is normally implemented by latch, flip-flop, or even small register file. Furthermore, when the area per bit and power per bit are large, it is common to implement the cache data storage in an array. Conversely, when the area per bit and the power per bit are small, the Write-Back Buffer 106 can be integrated into the cache data store. Instead of having a separate Write-Back Buffer 106 inside the cache array, a Reload Pointer 140 is added in the cache array to point to movable reload entry in the cache (delineated further in FIG. 1C). Victim entry gets a write-back to memory without moving it into a temporary Write-Back Buffer 106 since an empty slot or Reload entry, is always available for concurrent reload. In addition, Reload Pointer 140 moves around in the cache to an available empty slot created by write-back to prevent internal cache movement of data. If the Reload Pointer 140 is fixed to one location then the reload data has to be moved to another location before the next reload.

Turning now to FIG. 1C, illustrated is an exemplary improved process for operational flow of cache replacement. Here, a separate write-back buffer is eliminated. Within Cache 107, is at least one open slot in the cache array, coupled logically as a Reload entry.

When a cache miss occurs, and there is only one free entry, a new Victim is selected by victim pointer calculation logic. Then, New Data 103 is loaded in the reload buffer, simultaneously evicting the victim to a Bus 120 if the victim data has been updated with respect to Main System Memory. As soon as that operation completes, the Reload Pointer 140 gets updates.

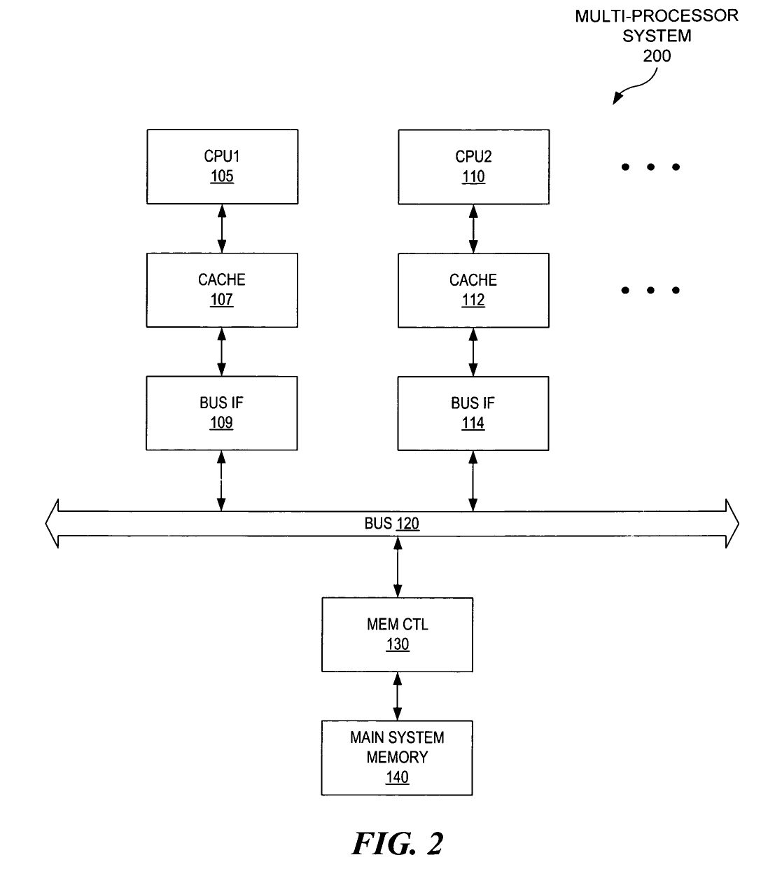

Turning to FIG. 2, disclosed is an exemplary processor cache SYSTEM 100 interface diagram. CPU1 105 and CPU2 110 store and retrieve indicia (data, commands, etc.) through their respective caches, 107, and 112, via a typical bus structure. Though there are two processors described here, operating in parallel, and without an apparent master/slave relationship, there can be ‘n’ number of processors in any configuration, with the same result. The bus interface units, BusIF 109 and BusIF 114 handle main memory requests from the cache system.

The cache systems 107 and 112 receive storage operations requests from processors, and access cache storages accordingly. If there is a cache miss in the cache system 107, for example, the cache system sends a request to BusIF 109 to access Main System Memory 140, or other cache in equal hierarchy to resolve cache miss. If there are ‘n’ processors with ‘x’ cache misses occurring simultaneously (either sequentially or in parallel), memory controller MEM CTL 130 determines and queues up the most urgent miss input/output. If there is no empty room in the cache storage to locate retrieved data for a cache miss, the cache system initiates a write-back request for victim entry to write victim data back to Main System Memory 140.

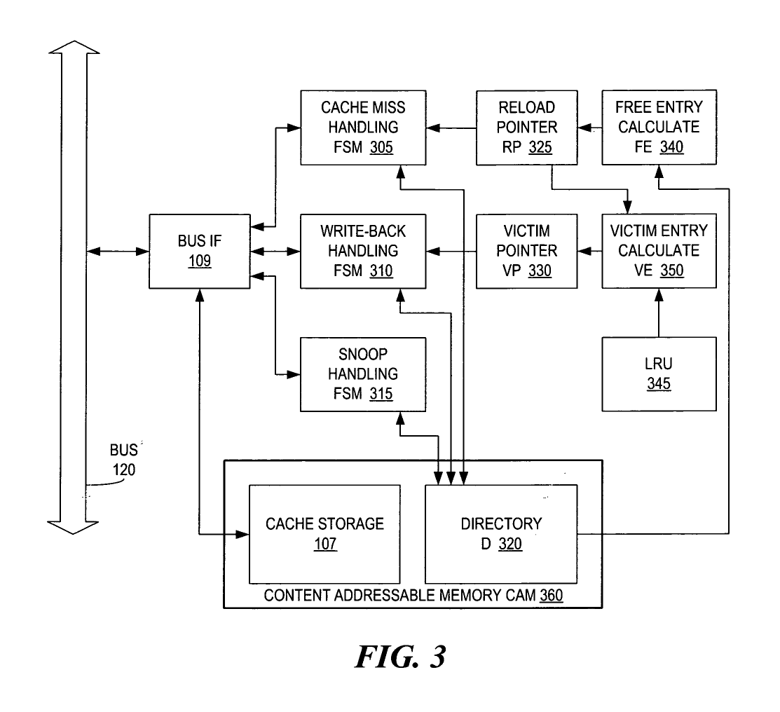

Turning to FIG. 3, disclosed is an exemplary cache system block diagram. Within this embodiment are three independent finite state machines (FSMs). Other embodiments can contain more or less FSMs.

FSM 305 handles cache misses. FSM 310 handles write-backs, and FSM 315 accepts and processes snoop requests from other devices hooked on the bus. There are two data pointers. RP 325 is the reload pointer for cache miss handling through FSM 305, and VP 330 is the victim pointer for write-back handling through FSM 310. Cache entry pointed by RP 325 has to be maintained in an empty condition whenever a cache miss occurs because retrieved data for the cache miss is located at the entry pointed by to by RP 325. If there is no free entry in the cache storage 107, (except an entry pointed at by RP 325 on need for cache miss handling), a write-back request will initiate for entry pointed to by VP 330. RP 325 is maintained to point at free entry by free entry calculation FE 340. After write-back is completed, RP 325 is updated by the value of the victim entry, since the victim entry is invalidated by the write-back request. This reload pointer maintenance then prepares for the next cache miss. VP 330 also updates by the output of victim pointer calculation in VP 330 to prepare for the next write-back request (in many instances, the Least Recently Used (LRU) algorithm also calculates for the VP 330 location). Since cache miss data is directly located into the entry pointed to by RP 325 and write-back data is written back directly from entry pointed by VP 330, unnecessary intra-cache data movement from victim entry to write-back entry can be avoided, improving performance and simplifying archive design. There is one directory, D 320 with corresponding cache storage area 107. The directory and cache are coupled, resulting in a Content Addressable Memory, CAM 360. Directory D 320 is for the storage of tag and cache states for data in corresponding cache storage locations. A tag is the information by which the target address can be associated with a particular directory. The cache state is the data attribute of cache entry to maintain cache coherency among multi-processor system connected via a single bus system. All cache systems must maintain overall cache coherency in terms of cache coherency protocol. Cache-miss finite state machine FSM 305, write-back finite state machine FSM 310, and snoop finite state machine FSM 315 communicate with directories, such as D 320, to retrieve information for target cache entry and to update cache state coherently. VE 350 gets information from a LRU 345 to calculate VP 330. BusIF 109 is the interface to bus 120 (where BUS 120 may be a system bus, a memory bus, Southbridge or other indicia communication pathway). All three finite state machines communicate through BusIF 109, sending and receiving requests through BUS 120.

A snoop request from the BusIF 109 initiates FSM 315 to begin work on a snoop command. BusIF 109 also handles data transfer between cache storage 107 and BUS 120 in accordance with request from one or more of the three finite state machines.

It is understood that the present invention can take many forms and implementations. Accordingly, several variations may be made in the foregoing without departing from the spirit or the scope of the invention. The capabilities outlined herein allow for the possibility of a variety of design and programming models. This disclosure should not be read as preferring any particular design or programming model, but is instead directed to the underlying mechanisms on which these design and programming models can be built.

Having thus described the present invention by reference to certain of its salient characteristics, it is noted that the features disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description. Accordingly, it is appropriate that the appended claims be construed broadly and in a manner consistent with the scope of the invention.

1. A data processing system, comprising:
a cache system;
a cache miss controller coupled to the cache system;
a write-back controller coupled to the cache system;
a snoop controller coupled to the cache system;
means for a write-back buffer;
means for a reload buffer;
means for a snoop; and
a plurality of data pointers,
wherein each data pointer is configured to select cache entry for specific purpose;
reload pointer selection logic means capable of selecting a reload buffer line;
victim selection logic means capable of determining the stalest line, through skipping over data pointers; and
a snoop logic means for snooping bus operations for reacting to other devices' requests.

2. The system of claim 1, further comprising said cache miss controller coupled via said reload selection logic to the reload buffer line.

3. The system of claim 1, further comprising said write-back controller coupled via said victim selection logic to the victim buffer line.

4. The system of claim 1, further comprising said snoop controller coupled to a directory.

5. The system of claim 3, further comprising the write-back controller configured to reserve the reload buffer as an empty buffer.

6. The system of claim 3, further comprising said write-back controller configured to specify the least-recently-used data line as the victim line.

7. A method for managing write-back and reload operations in a cache system, employing pointers and moveable buffers, comprising:
receiving storage access instructions in a cache system, wherein each said instruction loads from a processor;
storing pointers in said cache system, wherein each pointer is pointing to one of the entry in cache storage;
executing a victim entry selection operation from victim entry calculation logic;
executing a reload entry selection operation from free entry calculation logic;
determining a victim entry in accordance with the processor's demand storage access history;
determining a reload entry in accordance with all cache states;
reserving a buffer as an exclusive reload buffer to place retrieved data for cache miss handling;
executing write-back to memory from victim entry freeing space for further cache miss handling.

8. The method of claim 7, further comprising a step of pointing a victim entry by variable pointer.

9. The method of claim 7, further comprising a step of variably pointing a reload entry.

10. The method of claim 7, further comprising a step of the victim selection logic determining when modified data needs writing back to memory, freeing an entry for further cache miss handling.

11. The method of claim 7, further comprising a step of the victim selection logic addressing and skipping over reload pointer to find the least-recently-used stale buffer.

12. A computer program product for authenticating code in a computer system, the computer program product having a medium with a computer program embodied thereon, the computer program comprising:
computer code for generating parallel write-back and reload instructions through next victim selection logic; and
computer code for ordering a data buffer movement command having an associative data buffer pointer movement command.

13. A cache system for providing data storage and processing in a computer system, including a computer program comprising:
computer code for generating parallel write-back and reload instructions through next victim selection logic; and
computer code for moving a write-back buffer with computer code for moving a reload buffer having an associative data pointer movement command.
